(19) United States
(12) Patent Application Publication
(10) Pub. No.: US 2005/0190138 A1
(43) Pub. Date: Sep. 1, 2005

(54) LCD and method of driving the same

(76) Inventor: Tae-Hyeog Jung, Yangsan-si (KR)

Correspondence Address: CHRISTIE, PARKER & HALE, LLP, PO BOX 7068, PASADENA, CA, 91109-7068, US

(21) Appl. No.: 11/062,123

(22) Filed: Feb. 16, 2005

(30) Foreign Application Priority Data
Feb. 19, 2004 (KR) 2004-11154

(51) Int. Cl. G09G 3/36

(52) U.S. Cl. 345/96

(57) ABSTRACT

A method of driving a field sequential driving type liquid crystal display (LCD) which is capable of preventing crosstalk in a scan line direction from occurring, thereby improving its characteristic. In the LCD having a plurality of pixels for realizing desired colors for a predetermined period having R, G, B subframes for realizing red, green and blue colors, respectively, R, G, B data voltages are supplied to first electrodes of the pixels arranged in odd columns and even columns per each of the R, G, B subframes. Polarities of the data voltages in the odd columns are opposite to those in the even columns, and a common direct current (dc) voltage having the same level is supplied to second electrodes of the pixels. The pixels are reversely driven by the data voltages supplied to the first electrodes and the common dc voltage supplied to the second electrodes per each of the subframes on a column basis.

### CROSS-REFERENCE TO RELATED APPLICATION

This application claims priority to and the benefit of Korean Patent Application No. 10-2004-0011154, filed Feb. 19, 2004, the disclosure of which is incorporated herein by reference in its entirety.

### BACKGROUND OF THE INVENTION

1. Field of the Invention

The present invention relates to a column inversion driving type liquid crystal display (LCD), and more particularly, to a field sequential driving type LCD and method of driving the same, which is capable of improving crosstalk due to capacitive coupling.

2. Description of the Related Art

A field sequential driving type LCD allows turn on times of red (R), green (G), and blue (B) backlights to be different from one another with respect to one pixel so that the LCD is driven in a sequential manner, which differs from a color filter type LCD that has R, G, and B color filters to perform sequential scanning operations from a top end to a bottom end of a display screen. That is, one frame is divided into three subframes, wherein the R backlight is driven during a first subframe of the three subframes, the G backlight is driven during a second subframe, and the B backlight is driven during a third subframe, thereby representing a color image.

The field sequential driving type LCD includes a lower substrate where thin film transistors (TFT) are formed, an upper substrate as a counter substrate arranged to be opposite to the TFT substrate, and a liquid crystal interposed therebetween. The counter substrate has a common electrode for supplying a common voltage Vcom to all pixels, and the common electrode is comprised of a transparent conductive layer such as Indium Tin Oxide (ITO) and has a form of electrode covering the entire surface.

Liquid crystal is deteriorated due to its own property when a voltage having the same polarity is continuously applied thereto, so that positive voltage and negative voltage should be alternately applied to drive the liquid crystal. In the column driving type among these driving methods, driving voltages having different polarities from one another are supplied to adjacent cells among a plurality of liquid crystal cells arranged on scan lines where scan signals are supplied, and driving voltages having the same polarity are supplied to adjacent cells among a plurality of liquid crystal cells arranged on source lines where data signals are supplied.

Accordingly, as shown in FIGS. 1A and 1B, driving voltages having the same polarity are supplied to liquid crystal cells arranged in adjacent rows among a plurality of rows in each frame, and driving voltages having different polarities from one another are supplied to liquid crystal cells arranged in adjacent columns among a plurality of columns in each frame, thereby reverse-driving the liquid crystal on a column basis.

FIGS. 2A and 2B show signal waveforms of a driving voltage supplied to a liquid crystal when the liquid crystal of a conventional field sequential driving type LCD is driven in a column inversion manner. In particular, FIGS. 2A and 2B show the signal waveforms with respect to the driving voltage supplied to represent a black bar pattern 12 on a predetermined region of a display as shown in FIG. 3.

FIG. 2A shows the signal waveform of the driving voltage supplied to any one source line (data line) among a plurality of source lines (data lines) in any one frame, for example, an odd source line (data line) in the iₜₕ frame. FIG. 2B shows the signal waveform of the driving voltage supplied to any one source line (data line) among a plurality of source lines (data lines) in any one frame, for example, an even source line (data line) in the iₜₕ frame.

Referring to FIG. 2A, in R, G, and B subframes of the iₜₕ frame, source voltages applied to source electrodes of TFTs for driving the liquid crystal of pixels arranged in the odd source lines maintain the same polarity without any polarity inversion, and the common voltage Vcom is applied to the common electrode formed on the upper substrate with its polarity being reversed.

That is, in the common electrode of the pixels arranged in the odd source lines, Vcom having the negative polarity is supplied to the R subframe of the iₜₕ frame, Vcom having the positive polarity is supplied to the G subframe, and Vcom having the negative polarity is supplied to the B subframe.

Referring to FIG. 2B, in the R, G, and B subframes of the iₜₕ frame, source voltages applied to source electrodes of TFTs for driving the liquid crystal of pixels arranged in the even source lines maintain the same polarity without any polarity changes, and the common voltage Vcom applied to the common electrode formed on the upper substrate has its polarity reversed and has a voltage polarity opposite to that applied to the pixels arranged in the odd source lines.

Accordingly, in the common electrode of the pixels arranged in the even source lines, Vcom having the positive polarity is supplied to the R subframe of the iₜₕ frame, Vcom having the negative polarity is supplied to the G subframe, and Vcom having the positive polarity is supplied to the B subframe.

In FIG. 2A, R2 corresponds to a signal waveform of a source voltage supplied to liquid crystal cells arranged on scan lines G2-G5 among a plurality of liquid crystal cells arranged in the odd source line S3 of the iₜₕ frame in order to represent the black bar pattern as shown in FIG. 3, R1 corresponds to a signal waveform of a source voltage supplied to liquid crystal cells arranged on a scan line G1, and R3 corresponds to a signal waveform of a source voltage supplied to liquid crystal cells arranged on scan lines G6 and G7.

In FIG. 2B, R2 corresponds to a signal waveform of a source voltage supplied to liquid crystal cells arranged on scan lines G2-G5 among a plurality of liquid crystal cells arranged in the even source line S4 of the iₜₕ frame in order to represent the black bar pattern as shown in FIG. 3, R1 corresponds to a signal waveform of a source voltage supplied to liquid crystal cells arranged on a scan line G1, and R3 corresponds to a signal waveform of a source voltage supplied to liquid crystal cells arranged on scan lines G6 and G7.

Accordingly, in the conventional column inversion driving method, source voltages, which are supplied to the pixels arranged in the odd source lines and the even source lines per each of the R, G, and B subframes of the same frame, maintain their polarities while the polarity of the common voltage is reversed in the odd source lines, thereby realizing the column inversion as shown in FIGS. 1A and 1B.

When the column inversion driving is carried out as described above, a vertical capacitance is generated between the common electrode formed on the upper substrate as the counter substrate and data lines of the lower substrate on which TFTs are arranged, namely, source lines. As a result, whenever a transition of the data signal level is made from a high level to a low level or vice versa in each of the subframes, glitches occur in the common voltage due to the vertical capacitance generated between the data lines and the common electrode.

In the conventional column inversion driving method, as shown in FIGS. 2A and 2B, polarities of source voltages supplied to the odd source lines and the even source lines are not changed per each of the R, G, and B subframes of the same frame while the polarity of the common voltage is reversed, so that glitches a1 and b1 that occur whenever levels of the source voltages are changed in the odd source lines and glitches a2 and b2 that occur whenever levels of the source voltages are changed in the even source lines have the same polarity. Accordingly, the glitches that occur in the odd source lines and the even source lines within the same frame cause the crosstalk in a source line direction, namely, a scan line scan direction, which results in deterioration of the image quality.

FIG. 3 illustrates crosstalk that occurs when a black bar pattern is represented on a predetermined region of a display and white bar and black bar are represented on adjacent regions of the predetermined region, respectively in a conventional field sequential driving type LCD. In FIG. 3, the oblique line portion 11 represents one pixel.

When the black bar pattern 12 is represented on the predetermined region of the display 10 in the normally white mode LCD of 6×7, a difference between the source voltage Vs and the common voltage Vcom which are applied to liquid crystal cells, becomes relatively increased by the glitches that occur to the common voltage due to the capacitive coupling in the case that a pattern adjacent to the black bar pattern 12 is the white bar pattern 14 in a source line direction, namely, a scan line scan direction (i.e., the direction of the arrow shown in FIG. 3).

As a result, the level of the driving voltage applied to liquid crystal cells corresponding to the white bar pattern 14 increases as compared to that of the driving voltage applied to realize the original white bar pattern, which causes transmissivity to be decreased. Accordingly, the white bar pattern 14 is displayed as dark white color due to the crosstalk rather than pure white that should be displayed.

Further, when the pattern 13 adjacent to the black bar pattern 12 is a black bar pattern in a source line direction, namely, a scan line scan direction, the difference between the source voltage Vs and the common voltage Vcom which are applied to liquid crystal cells becomes relatively decreased by glitches that occur to the common voltage due to the capacitive coupling.

Accordingly, the level of the driving voltage applied to liquid crystal cells corresponding to the black bar pattern 13 becomes lower, which causes the transmissivity to be increased. As a result, the black bar pattern 13 is displayed as light black due to the crosstalk rather than pure black that should be displayed.

### SUMMARY OF THE INVENTION

In exemplary embodiments according to present invention, therefore, is provided a solution to aforementioned problems by providing an LCD capable of improving the image quality and method of driving the same.

In exemplary embodiments according to the present invention, is also provided an LCD capable of preventing crosstalk resulting from capacitive coupling and method of driving the same.

In an exemplary embodiment according to the present invention, in a liquid crystal display (LCD) including a plurality of pixels arranged in a plurality of columns and rows, each of the pixels having a first electrode, a second electrode, and a liquid crystal interposed between the first and second electrodes, a method of driving the LCD includes: supplying voltage signals to the first electrodes of pixels arranged in odd columns and even columns among the plurality of pixels, polarities of the voltage signals in the odd columns being opposite to those in the even columns; and supplying voltage signals having the same polarity to the second electrodes of the pixels arranged in the odd columns and the even columns among the plurality of pixels. The plurality of pixels are reversely driven by the voltage signals supplied to the first and second electrodes for a predetermined period on a column basis.

The predetermined period may be one frame, and data voltages may be supplied to the first electrodes of the pixels arranged in the odd columns and the even columns during the one frame, polarities of the data voltages in the odd columns being opposite to those in the even columns, and a common voltage having a direct current (dc) level may be supplied to the second electrodes of the pixels arranged in the odd columns and the even columns.

The predetermined period may be one frame and may be divided into at least two fields, and the voltage signals may be supplied to the first electrodes of the pixels arranged in the odd columns and the even columns during at least one of the fields, polarities of the voltage signals supplied to the first electrodes in the odd columns being opposite to those in the even columns, and the voltage signals having the same polarity may be supplied to the second electrodes of the pixels arranged in the odd columns and the even columns.

Data voltages may be supplied to the first electrodes of the pixels arranged in the odd columns and the even columns during at least one of the fields, polarities of the data voltages in the odd columns being opposite to those in the even columns, and a common voltage having a direct current (dc) level may be supplied to the second electrodes of the pixels arranged in the odd columns and the even columns.

Voltage signals having polarities different from one another may be supplied to the first electrodes of the pixels arranged in the same odd column or in the same even column in adjacent two fields of the at least two fields, and the voltage signals having the same polarity may be supplied to the second electrodes of the pixels.

Data voltages having polarities different from one another may be supplied to the first electrodes of the pixels arranged in the same odd column or in the same even column in adjacent two fields of the at least two fields, and a common voltage having a direct current (dc) level may be supplied to the second electrodes of the pixels arranged in the same odd column or in the same even column.

The plurality of pixels may realize at least one of red (R), green (G), blue (B), and white (W) colors.

The predetermined period may be one frame and may be divided into at least two subframes, and the voltage signals may be supplied to the first electrodes of the pixels arranged in the odd columns and the even columns among the plurality of pixels during at least one of the subframes, polarities of the voltage signals in the odd columns being opposite to those in the even columns, and the voltage signals having the same polarity may be supplied to the second electrodes of the pixels arranged in the odd columns and the even columns, and the plurality of pixels may be reversely driven by the voltage signals supplied to the first and second electrodes per each of the subframes on a column basis.

Data voltages may be supplied to the first electrodes of the pixels arranged in the odd columns and the even columns during one of the at least two subframes, polarities of the data voltages in the odd columns being opposite to those in the even columns, and a common voltage having a direct current (dc) level may be supplied to the second electrodes of the pixels arranged in the odd columns and the even columns.

In another exemplary embodiment according to the present invention, in a liquid crystal display (LCD) including a plurality of pixels sequentially driven per each of several subframes constituting one frame and arranged in a plurality of columns and rows, each of the pixels including a first electrode, a second electrode, and a liquid crystal interposed between the first and second electrodes, a method of driving the LCD includes: supplying voltage signals to pixels arranged in odd columns or in even columns among the plurality of pixels, polarities of the voltage signals being opposite to those in each of the same odd columns or in each of the same even columns in adjacent subframes of the several subframes, and supplying voltage signals having the same level to the second electrodes; and supplying voltage signals to the first electrodes of the pixels arranged in the odd columns and the even columns, polarities of the voltage signals in the odd columns being opposite to those in the even columns in the same subframe, and supplying voltage signals having the same level to the second electrodes.

In yet another exemplary embodiment according to the present invention, in a liquid crystal display (LCD) including a plurality of pixels arranged in a plurality of columns and rows, each of the pixels realizing a desired color during a predetermined period and including a first electrode, a second electrode, and a liquid crystal interposed between the first and second electrodes, a method of driving the LCD includes: preparing the predetermined period to have a R subframe for realizing a red (R) color, a G subframe for realizing a green (G) color, and a B subframe for realizing a blue (B) color; supplying R, G, and B data voltages to the first electrodes of pixels arranged in odd columns and even columns among the plurality of pixels per each of the R, G, and B subframes, polarities of the data voltages in the odd columns being opposite to those in the even columns; and supplying a common direct current (dc) voltage having the same level to the second electrodes of the pixels arranged in the odd and even columns per each of the R, G, and B subframes. The plurality of pixels are reversely driven by the R, G, B data voltages supplied to the first electrodes and the common dc voltage supplied to the second electrodes per each of the subframes on a column basis.

In still another exemplary embodiment according to the present invention, a liquid crystal display (LCD) includes: a plurality of pixels arranged in a plurality of rows and columns, each of the pixels including a first electrode arranged on a lower substrate, a second electrode arranged on an upper substrate, a plurality of liquid crystal cells having a liquid crystal interposed between the upper and lower substrates, and a switching transistor having at least source and drain electrodes for driving the plurality of liquid crystal cells. The first electrode of the liquid crystal cell is connected to one of the source and drain electrodes of the switching transistor, and the second electrode is formed to be an entire surface electrode on the upper substrate. Voltage signals are supplied to the first electrodes of the liquid crystal cells arranged in odd columns and even columns among the plurality of liquid crystal cells within the same subframe, polarities of the voltage signals in the odd columns being opposite to those in the even columns, and voltage signals having the same polarity are supplied to the second electrodes. The plurality of liquid crystal cells are reversely driven by the voltage signals supplied to the first and second electrodes per each subframe on a column basis.

### BRIEF DESCRIPTION OF THE DRAWINGS

The above and other features of the present invention will be described in reference to certain exemplary embodiments thereof with reference to the attached drawings in which:

FIGS. 1A and 1B show polarities of driving voltages applied to liquid crystal cells on a liquid crystal panel in adjacent frames when a field sequential driving type LCD is driven in a column inversion manner;

FIGS. 2A and 2B show signal waveforms of driving voltages applied to liquid crystal cells arranged in adjacent scan lines of a liquid crystal panel within any one frame when a conventional field sequential driving type LCD is driven in a column inversion manner;

FIG. 3 is a view for explaining horizontal crosstalk that occurs when a conventional field sequential driving type LCD is driven in a column inversion manner;

FIG. 4 is a schematic view illustrating a circuit configuration of a field sequential driving type LCD in accordance with an exemplary embodiment of the present invention;

FIG. 5 is a schematic cross sectional view of a field sequential driving type LCD in accordance with an exemplary embodiment of the present invention;

FIGS. 6A and 6B show signal waveforms of driving voltages applied to liquid crystal cells arranged in adjacent scan lines of a liquid crystal panel within any one frame when a field sequential driving type LCD is driven in a column inversion manner in accordance with an exemplary embodiment of the present invention; and

FIG. 7 is a view illustrating improved horizontal crosstalk when a field sequential driving type LCD is driven in a column inversion manner in accordance with an exemplary embodiment of the present invention.

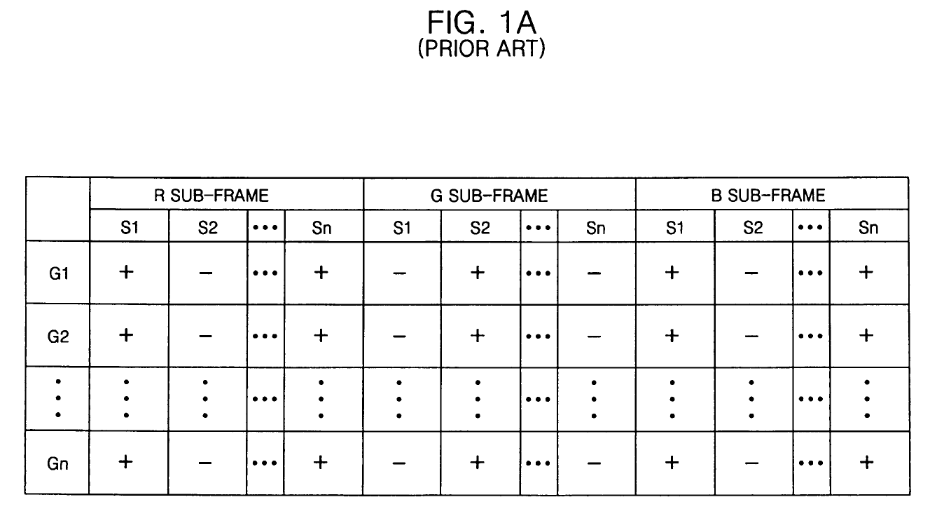

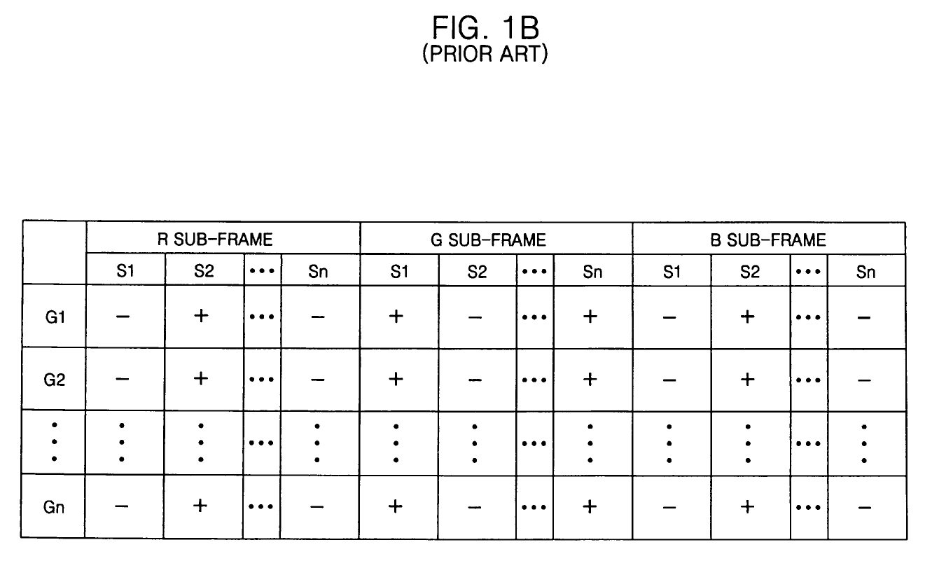

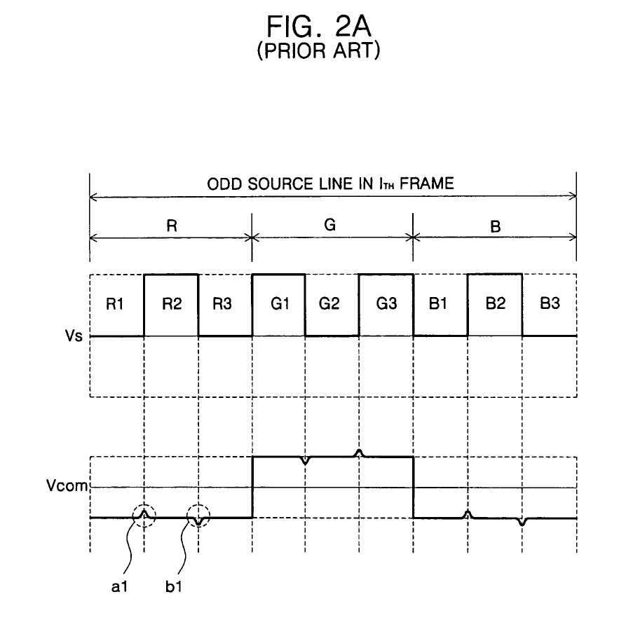

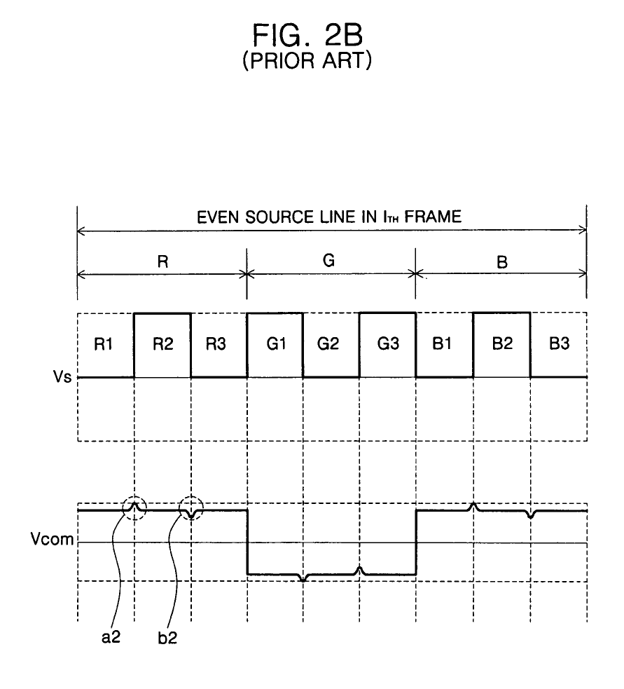

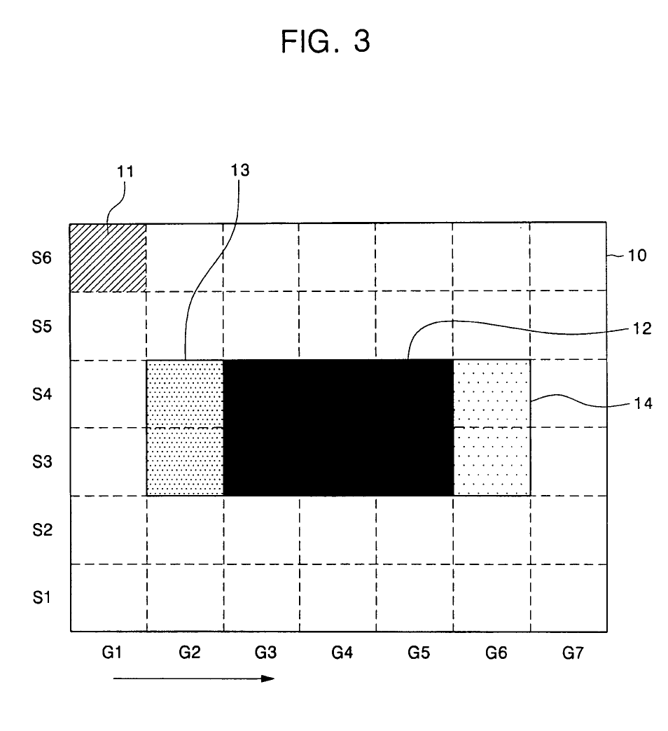

### DETAILED DESCRIPTION

Hereinafter, exemplary embodiments of the present invention will be described with reference to accompanying drawings.

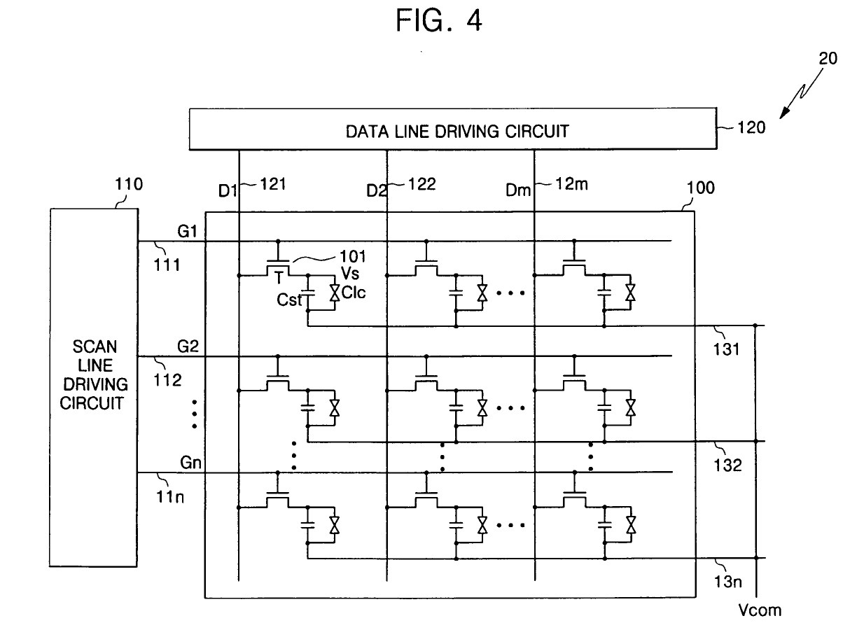

FIG. 4 is a schematic view illustrating a circuit configuration of a field sequential driving type LCD in accordance with an exemplary embodiment of the present invention.

Referring to FIG. 4, a color field sequential driving type LCD 20 includes a liquid crystal panel 100, a scan line driving circuit 110, and a data line driving circuit 120. The liquid crystal panel 100 includes a plurality of pixels 101, which are connected to a plurality of scan lines 111-11n, a plurality of data lines 121-12m, and common power lines 131-13n. Each pixel 101 has a switching transistor T connected to a corresponding one scan line among the plurality of scan lines 111-11n and for delivering a data signal from a corresponding one data line among the plurality of data lines 121-12m, a liquid crystal cell C_{LC} to which R, G and B data voltages Vs delivered through the switching transistor T and a common voltage Vcom delivered from a corresponding one common power line among the common power lines 131-13n are applied at its respective ends, and a storage capacitor Cst for storing the data signal Vs applied to the liquid crystal cell C_{LC} through the switching transistor T.

The scan line driving circuit 110 provides corresponding scan signals G1-Gn to the plurality of scan lines 111-11n of the liquid crystal panel 100, and the data line driving circuit 120 sequentially provides corresponding R, G, and B data signals Vs to the plurality of data lines 121-12n of the liquid crystal panel 100. A common voltage Vcom is supplied to each pixel through the plurality of common power lines 131-13n from a common voltage generating circuit, which is not shown in FIG. 4.

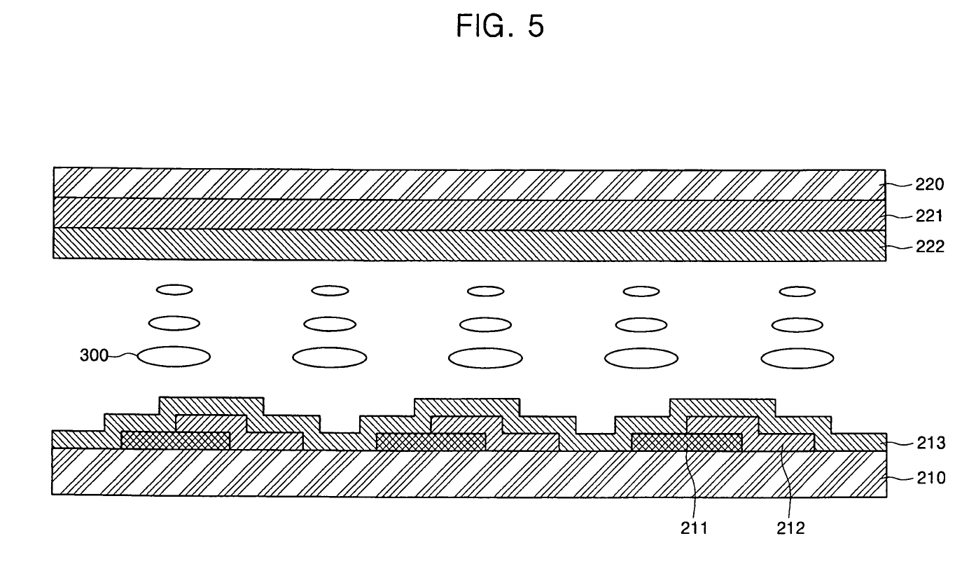

FIG. 5 is a schematic cross sectional view of a color field sequential driving type LCD in accordance with an exemplary embodiment of the present invention. FIG. 5 shows pixels arranged in any one column or one row among a plurality of columns and rows.

Referring to FIG. 5, an LCD in accordance with an exemplary embodiment of the present invention includes a lower substrate 210, an upper substrate 220, and a liquid crystal 300 interposed between the upper and lower substrates 220 and 210. The lower substrate 210 has formed thereon a switching TFT 211, and a pixel electrode 212 connected to one of source and drain electrodes, e.g., the source electrode, of the switching TFT 211. The upper substrate 220 has formed thereon a common electrode 221, which is formed as an entire surface electrode. In addition, the upper and lower substrates 220 and 210 further have formed thereon an upper alignment layer 222 and a lower alignment layer 213, respectively, for aligning the liquid crystal 300 interposed between the upper and lower substrates in a uniform direction.

The switching TFT 211 of FIG. 5 corresponds to the switching transistor T of FIG. 4, a first electrode of the liquid crystal cell C_{LC} and the storage capacitor Cst corresponds to the pixel electrode 212 connected to the switching TFT 211, and a second electrode of the liquid crystal cell C_{LC} and the storage capacitor Cst corresponds to the common electrode 221 formed on the upper substrate 220. The pixel electrode 212 and the common electrode 213 are formed of a transparent conductive layer such as ITO.

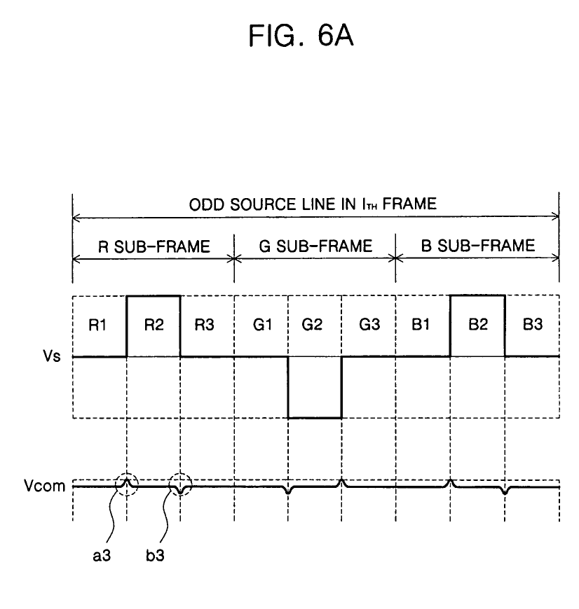

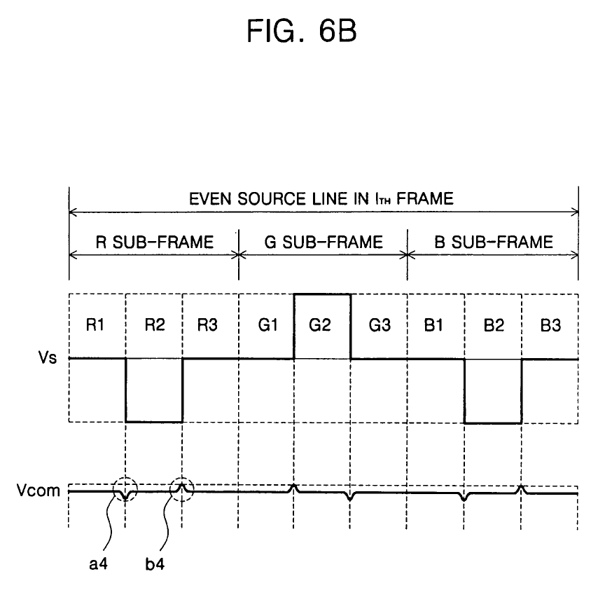

Hereinafter, operations of the field sequential driving type LCD having the above-mentioned configuration according to exemplary embodiments of the present invention will be described with reference to signal waveforms shown in FIGS. 6A and 6B.

FIG. 6A shows a signal waveform of a driving voltage applied to pixels arranged in odd data lines among a plurality of data lines in a current iₜₕ frame. In FIG. 6A, a common voltage Vcom applied to the common electrode 221 as a second electrode is provided with a direct current (dc) voltage having the same level in one frame. As a result, a common voltage applied to second electrodes of pixels arranged in the odd source lines is provided with a dc voltage having the same level in each of R, G, and B subframes within the same frame.

Further, a data voltage Vs applied to the pixel electrode 213 as a first electrode is provided with voltages having different polarities from one another per each of R, G, and B subframes in one frame. For example, a data voltage Vs having a positive polarity is provided in the R subframe for realizing a red color, and a data voltage Vs having a negative polarity, which is opposite to that of the data voltage Vs provided during the R subframe, is provided in the G subframe for realizing a green color. In addition, a data voltage Vs having a positive polarity, which is opposite to that of the data voltage Vs provided during the G subframe, is provided in the B subframe for realizing a blue color.

FIG. 6B shows a signal waveform of a driving voltage applied to pixels arranged in even data lines (i.e., even source lines) among a plurality of data lines in the current iₜₕ frame. In FIG. 6B, a common voltage Vcom applied to the common electrode 221 as a second electrode is provided with a dc voltage having the same level in one frame. As a result, the common voltage applied to the second electrode of the pixels arranged in the even source lines is provided with a dc voltage having the same level in each of R, G, and B subframes within the same frame.

Further, a data voltage Vs applied to the pixel electrode 213 as a first electrode is provided with voltages having different polarities from one another per each of R, G, and B subframes in one frame. For example, a data voltage Vs having a negative polarity is provided in the R subframe for realizing the red color, and a data voltage Vs having a positive polarity, which is opposite to that of the data voltage Vs provided during the R subframe, is provided in the G subframe for realizing the green color. In addition, a data voltage Vs having a negative polarity, which is opposite to that of the data voltage Vs provided during the G subframe, is provided in the B subframe for realizing the blue color.

Accordingly, as shown in FIGS. 6A and 6B, second electrodes of pixels arranges in the odd data lines and the even data lines in the R subframe within any one frame are provided with dc voltages having the same level as the common voltage Vcom, and first electrodes of the pixels are provided with data voltages Vs having different polarities from one another. Second electrodes of pixels arranged in the odd data lines and the even data lines are provided with dc voltages having the same level as the common voltage Vcom in the G subframe, and first electrodes of the pixels are provided with data voltages Vs having different polarities from one another. Finally, second electrodes of pixels arranged in the odd data lines and the even data lines are provided with dc voltages having the same level as the common voltage Vcom in the B subframe, and first electrodes of the pixels are provided with data voltages Vs having different polarities from one another. This way, the pixels are reversely driven by the voltage signals supplied to the first and second electrodes for a predetermined period on a column basis.

Accordingly, the second electrodes of the pixels arranged in the odd data lines and the even data lines are provided with the dc voltages having the same level as the common voltage Vcom within one frame having the R, G, and B subframes. The first electrodes of the pixels arranged in the odd data lines are provided with the data voltages Vs having different polarities from one another per each of the R, G, and B subframes of the one frame, and the first electrodes of the pixels arranged in the even data lines are provided with the data voltages Vs having different polarities from one another per each of the R, G, and B subframes of the one frame. As a result, the pixels arranged in the odd data lines and the even data lines are provided not only with the data voltages having different polarities from one another per each of the R, G, and B subframes of the one frame but also with the data voltages having different polarities from one another even in the same subframe, thereby realizing the column inversion for reverse-driving the polarity of the data voltage on a column basis.

In the exemplary embodiments of the present invention, the dc voltages having the same level are supplied to the pixels arranged in the odd data lines and the even data lines in the R, G, and B subframes of any one frame (e.g., iₜₕ frame), and alternating current (ac) voltages having different polarities from one another are provided as the data voltages to carry out the reverse drive on a column basis, so that polarities of glitches a3 and b3 that occur in the odd pixels due to capacitive coupling become different from glitches a4 and b4 in the even pixels whenever a transition of data voltages is made from a high level to a low level or vice versa. Accordingly, the glitches are offset on the common voltage in one frame or one subframe, thereby preventing crosstalk due to the capacitive coupling from occurring in a scan line scan direction, thereby reducing or eliminating such a crosstalk.

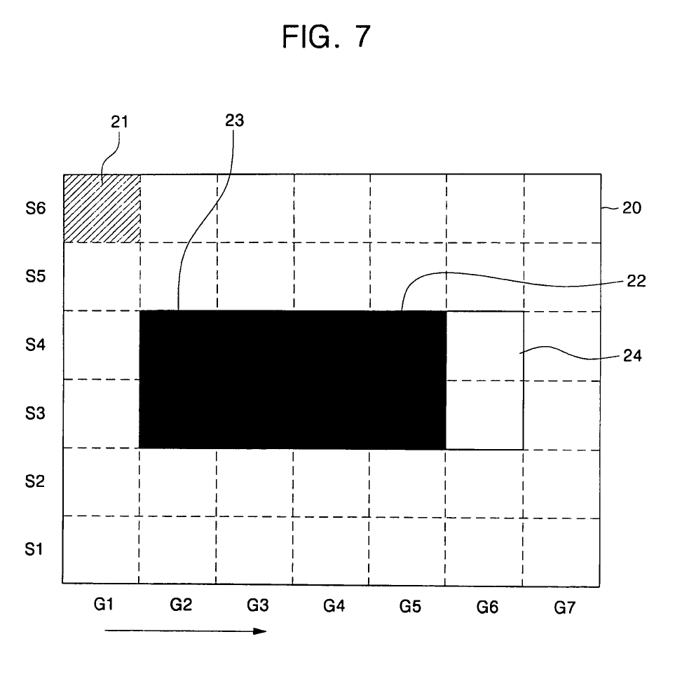

FIG. 7 is a view illustrating an improved horizontal crosstalk when a field sequential driving type LCD is driven in a column inversion manner in accordance with an exemplary embodiment of the present invention.

Referring to FIG. 7, when a black bar pattern 22 is displayed on a predetermined region of the LCD in the 6×7 normally white mode, as mentioned above, polarities of glitches that occur in a common voltage applied to pixels arranged in odd data lines and even data lines become different from each other, such that they are offset even when glitches occur to the common voltage due to the capacitive coupling in the case where a pattern adjacent to the black bar pattern 22 is a white bar pattern 24 in a source line direction, namely, a scan line scan direction (the direction of arrow). Accordingly, a driving voltage for realizing the original white bar pattern is supplied to pixels corresponding to the white bar pattern 24, thereby representing desired white bar patterns.

Further, the polarities of the glitches that occur in the common voltage applied to the pixels arranged in the odd data lines and the even data lines become different from each other, such that they are offset even when the glitches occur to the common voltage due to the capacitive coupling in the case where a pattern 23 adjacent to the black bar pattern 22 is a black bar pattern in a data line direction, namely, a scan line scan direction. Accordingly, a driving voltage for realizing the original black bar pattern is supplied to pixels corresponding to the black bar pattern 23, thereby representing desired black bar patterns.

Certain exemplary embodiments of the present invention have been described with respect to the field sequential driving type LCD, however, the present invention may be applied to all LCDs, which may have the crosstalk that occur due to capacitive coupling in a scan line scan direction by reversing polarities of glitches occurred in pixels arranged in the even data lines and the odd data lines. In addition, it may be applied to displaying a single color of red, green, blue or white, or a combination of at least the two colors.

As mentioned above, in the field sequential driving type LCD in accordance with the exemplary embodiments of the present invention, polarities of glitches that occur in the odd data lines and the even data lines within subframes constituting one frame are reversed to allow the glitches due to capacitive coupling to be offset, thereby preventing the crosstalk from occurring and improving the image quality.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

1. In a liquid crystal display (LCD) comprising a plurality of pixels arranged in a plurality of columns and rows, each of the pixels including a first electrode, a second electrode, and a liquid crystal interposed between the first and second electrodes, a method of driving the LCD comprising:
supplying voltage signals to the first electrodes of pixels arranged in odd columns and even columns among the plurality of pixels, polarities of the voltage signals in the odd columns being opposite to those in the even columns; and
supplying voltage signals having the same polarity to the second electrodes of the pixels arranged in the odd columns and the even columns among the plurality of pixels,
wherein the plurality of pixels are reversely driven by the voltage signals supplied to the first and second electrodes for a predetermined period on a column basis.

2. The method of claim 1, wherein the predetermined period is one frame, and data voltages are supplied to the first electrodes of the pixels arranged in the odd columns and the even columns during the one frame, polarities of the data voltages in the odd columns being opposite to those in the even columns, and a common voltage having a direct current (dc) level is supplied to the second electrodes of the pixels arranged in the odd columns and the even columns.

3. The method of claim 1, wherein the predetermined period is one frame and is divided into at least two fields, and the voltage signals are supplied to the first electrodes of the pixels arranged in the odd columns and the even columns during at least one of the fields, polarities of the voltage signals supplied to the first electrodes in the odd columns being opposite to those in the even columns, and the voltage signals having the same polarity are supplied to the second electrodes of the pixels arranged in the odd columns and the even columns.

4. The method of claim 3, wherein data voltages are supplied to the first electrodes of the pixels arranged in the odd columns and the even columns during at least one of the fields, polarities of the data voltages in the odd columns being opposite to those in the even columns, and a common voltage having a direct current (dc) level is supplied to the second electrodes of the pixels arranged in the odd columns and the even columns.

5. The method of claim 3, wherein voltage signals having polarities different from one another are supplied to the first electrodes of the pixels arranged in the same odd column or in the same even column in adjacent two fields of the at least two fields, and the voltage signals having the same polarity are supplied to the second electrodes of the pixels.

6. The method of claim 4, wherein data voltages having polarities different from one another are supplied to the first electrodes of the pixels arranged in the same odd column or in the same even column in adjacent two fields of the at least two fields, and a common voltage having a dc level is supplied to the second electrodes of the pixels arranged in the same odd column or in the same even column.

7. The method of claim 6, wherein the plurality of pixels realize at least one of red (R), green (G), blue (B), and white (W) colors.

8. The method of claim 1, wherein the predetermined period is one frame and is divided into at least two subframes, and the voltage signals are supplied to the first electrodes of the pixels arranged in the odd columns and the even columns among the plurality of pixels during at least one of the subframes, polarities of the voltage signals in the odd columns being opposite to those in the even columns, and the voltage signals having the same polarity are supplied to the second electrodes of the pixels arranged in the odd columns and the even columns, and the plurality of pixels are reversely driven by the voltage signals supplied to the first and second electrodes per each of the subframes on a column basis.

9. The method of claim 8, wherein data voltages are supplied to the first electrodes of the pixels arranged in the odd columns and the even columns during one of the at least two subframes, polarities of the data voltages in the odd columns being opposite to those in the even columns, and a common voltage having a direct current (dc) level is supplied to the second electrodes of the pixels arranged in the odd columns and the even columns.

10. The method of claim 8, wherein the plurality of pixels realize at least one of red (R), green (G), blue (B), and white (W) colors.

11. In a liquid crystal display (LCD) comprising a plurality of pixels sequentially driven per each of several subframes constituting one frame and arranged in a plurality of columns and rows, each of the pixels including a first electrode, a second electrode, and a liquid crystal interposed between the first and second electrodes, a method of driving the LCD comprising:
supplying voltage signals to pixels arranged in odd columns or in even columns among the plurality of pixels, polarities of the voltage signals being opposite to those in each of the same odd columns or in each of the same even columns in adjacent subframes of the several subframes, and supplying voltage signals having the same level to the second electrodes; and
supplying voltage signals to the first electrodes of the pixels arranged in the odd columns and the even columns, polarities of the voltage signals in the odd columns being opposite to those in the even columns in the same subframe, and supplying voltage signals having the same level to the second electrodes.

12. The method of claim 11, wherein data voltages are supplied to the first electrodes of the pixels arranged in the odd columns and the even columns during the same subframe of the several subframes, polarities of the data voltages in the odd columns being opposite to those in the even columns, and a common voltage having a direct current (dc) level is supplied to the second electrodes of the pixels arranged in the odd columns and the even columns.

13. The method of claim 11, wherein data voltages are supplied to the first electrodes of pixels arranged in the same odd column or in the same even column in adjacent subframes among the plurality of the pixels, polarities of the data voltages being different from one another in each of the odd columns or in each of the even columns, and a common voltage having a direct current (dc) level is supplied to the second electrodes of the pixels arranged in the odd columns and the even columns.

14. The method of claim 11, wherein the plurality of pixels realize at least one of red (R), green (G), blue (B), and white (W) colors during one of the several subframes.

15. In a liquid crystal display (LCD) comprising a plurality of pixels arranged in a plurality of columns and rows, each of the pixels realizing a desired color during a predetermined period and including a first electrode, a second electrode, and a liquid crystal interposed between the first and second electrodes, a method of driving the LCD comprising:
preparing the predetermined period to have a R subframe for realizing a red (R) color, a G subframe for realizing a green (G) color, and a B subframe for realizing a blue (B) color;
supplying R, G, and B data voltages to the first electrodes of pixels arranged in odd columns and even columns among the plurality of pixels per each of the R, G, and B subframes, polarities of the data voltages in the odd columns being opposite to those in the even columns; and
supplying a common direct current (dc) voltage having the same level to the second electrodes of the pixels arranged in the odd and even columns per each of the R, G, and B subframes,
wherein the plurality of pixels are reversely driven by the R, G, B data voltages supplied to the first electrodes and the common dc voltage supplied to the second electrodes per each of the subframes on a column basis.

16. The method of claim 15, wherein corresponding data voltages among the R, G, B data voltages are supplied to the first electrodes of pixels arranged in the same odd column or in the same even column among the plurality of pixels in adjacent subframes among the subframes, polarities of the data voltages being different from one another in each of the odd columns or in each of the even columns, and the common dc voltage is supplied to the second electrodes.

17. A liquid crystal display (LCD) comprising:
a plurality of pixels arranged in a plurality of rows and columns, each of the pixels including a first electrode arranged on a lower substrate, a second electrode arranged on an upper substrate, a plurality of liquid crystal cells having a liquid crystal interposed between the upper and lower substrates, and a switching transistor having at least source and drain electrodes for driving the plurality of liquid crystal cells,
wherein the first electrode of the liquid crystal cell is connected to one of the source and drain electrodes of the switching transistor, and the second electrode is formed as an entire surface electrode on the upper substrate, wherein voltage signals are supplied to the first electrodes of the liquid crystal cells arranged in odd columns and even columns among the plurality of liquid crystal cells within the same subframe, polarities of the voltage signals in the odd columns being opposite to those in the even columns, and voltage signals having the same polarity are supplied to the second electrodes, and wherein the plurality of liquid crystal cells are reversely driven by the voltage signals supplied to the first and second electrodes per each subframe on a column basis.

18. The liquid crystal display of claim 17, wherein data voltages are supplied to the first electrodes of the liquid crystal cells arranged in the odd columns and the even columns within the same subframe, polarities of the data voltages in the odd columns being opposite to those in the even columns, and a common direct current (dc) voltage having the same level is supplied to the second electrodes of the pixels.

19. The liquid crystal display of claim 17, wherein data voltages are supplied to the first electrodes of the pixels arranged in the odd columns or in the even columns in adjacent subframes, polarities of the data voltages being different from one another in each of the odd columns or in each of the even columns, and a common direct current (dc) voltage having the same level is supplied to the second electrodes of the pixels.
